(19) United States
(12) Patent Application Publication
(10) Pub. No.: US 2007/0014027 A1
(43) Pub. Date: Jan. 18, 2007

(54) Projection device

(76) Inventors: Ken Agatsuma, Tokyo (JP); Shohei Matsuoka, Tokyo (JP)

Correspondence Address: PITNEY HARDIN LLP, 7 TIMES SQUARE, NEW YORK, NY, 10036-7311, US

(21) Appl. No.: 11/484,902

(22) Filed: Jul. 12, 2006

(30) Foreign Application Priority Data
Jul. 12, 2005 (JP) 2005-202796

(51) Int. Cl. G02B 3/00

(52) U.S. Cl. 359/649

(57) ABSTRACT

A projection device is provided with an image source configured to emit light carrying an image having a rectangular shape, a first projecting optical system configured to form an intermediate image carried by the light emitted by the image source, the intermediate image having a trapezoidal shape due to trapezoidal distortion, an intermediate optical system configured to deflect light forming the intermediate image, a second projecting optical system configured to obliquely project light deflected by the intermediate optical system to a screen of the projection device, the image projected on the screen having a shape similar to the image provided by the image source. Each of the first projecting optical system and the second projecting optical system may be configured to be substantially telecentric toward the intermediate image.

### BACKGROUND OF THE INVENTION

The present invention relates to a projection device configured to obliquely project an image formed on an image source to a screen using a trapezoidal intermediate image.

Conventionally, a projection device that obliquely projects an image displayed on an image source unit onto a screen has been known. It is noted that, in the following description, a term “projection device” represents the obliquely displaying type project device as described above.

Generally, the projection device is configured such that an image source displays an image to be projected on the screen. The image is typically a rectangular shape with a predetermined aspect ratio. Using a first optical system, light carrying the image displayed by the image source is converged on an intermediate image plane. It is noted that the light is obliquely incident on the intermediate image plane, and the image formed on the intermediate image plane has a trapezoidal shape. Next, the image formed on the intermediate image plane is projected on the screen using a second optical system. The light is also incident on the screen obliquely such that the trapezoidal shape of the intermediate image is re-shaped and a rectangular image is formed on the screen.

Further, the image source, the first optical system and an intermediate image plane are arranged to satisfy Scheinpflug's law. Similarly, the intermediate image plane, the second optical system and the screen are arranged to satisfy Scheinpflug's law. With such a configuration, the image displayed on the image source unit can be displayed on the screen by obliquely incident light carrying the image with focused condition.

An example of such an projection device is disclosed in Japanese Patent Provisional Publication No. HEI 06-265814 (hereinafter, referred to as '814 publication).

The projection device as disclosed in '814 publication is generally provided with an intermediate optical system (deflecting optical system) that introduce the intermediate image formed by the first optical system to the second optical system. The intermediate optical system is required to have three optical functions:

(1) a function of efficiently receiving light emitted by the first optical system;

(2) a function of adjusting divergence of light emerged from the intermediate optical system so that the emerged light is efficiently received by the second optical system; and

(3) a function of a prism that bends an optical path of the incident light in a vertical direction when the projection device is in use.

In this type of projection device, optical elements in each of the first optical system and the second optical system are inclined with respect to the optical axes of the first and second optical systems, respectively. The optical axis of the first optical system (or the second optical system) is defined such that a line including the most of the central axes of the optical surfaces in the optical system. If all the central axes of the optical surfaces are shifted from each other, a line including the central axis of the optical surface closest to a pupil will be defined as the optical axis of the optical system. Further, a term incline indicates that the central axis of an element is inclined with respect to the optical axis of the optical system.

Since each optical element is arranged inclined with respect to the optical axis, light emerged from the first optical system and light emerged from the intermediate optical system have different divergences in the vicinity of the intermediate optical system in the horizontal and vertical directions. Therefore, in order to realize functions (1) and (2) above, the intermediate optical system is required to have different powers in the horizontal and vertical directions. In such a case (i.e., optical elements having different powers in different directions are employed), it is necessary to suppress various asymmetrical aberrations.

In '814 publication, the intermediate optical system is configured to include two Fresnel lenses. Specifically, by decentering the each Fresnel lens, the above described three functions are realized with suppressing various aberrations.

According to the configuration of '814 publication, however, very high performance Fresnel lenses should be designed at a high accuracy. Further, the thus designed and manufactured Fresnel lenses are used as decentered. Therefore, it is necessary to manufacture the lens such that a peripheral portion thereof also exhibit a high optical performance, although it is generally said to manufacture the peripheral portion with high accuracy. Therefore, a manufacturing cost will increase and yield is said to be low.

### SUMMARY OF THE INVENTION

Aspects of the invention provide a projection device of oblique incident type capable of employing an intermediate optical system that can be manufactured efficiently and inexpensively.

According to aspects of the invention, there is provided a projection device, which is provided with an image source unit configured to emit light carrying an image having a rectangular shape, a first projecting optical system configured to form an intermediate image carried by the light emitted by the image source unit, the intermediate image having a trapezoidal shape due to trapezoidal distortion, a second projecting optical system, and an intermediate optical system configured to lead light from the first projecting optical system to the second projecting optical system, the second projecting optical system being configured to obliquely project light deflected by the intermediate optical system to a screen of the projection device, the image projected on the screen having a shape similar to the image provided by the image source. Each of the first projecting optical system and the second projecting optical system is configured to be substantially telecentric toward the intermediate image.

According to the above configuration, burdens of the intermediate optical system to at lease the first and second functions described above are significantly reduced. That is, in such a configuration, the intermediate optical system is required to have only the third optical function described above.

The first projecting optical system may be configured such that, on a plane including the optical axes of he first projecting optical system and the second projecting optical system, a first angular difference between an angle formed between a chief ray of light emitted from a lower end of the image source and an optical axis of the first projecting optical system and an angle formed between a chief ray of light emitted from an upper end of the image source and the optical axis of the first projecting optical system is smaller than a convergence angle of a light beam emitted from a central portion of the image source and incident on the intermediate optical system as a converging beam via the first projecting optical system. The second projecting optical system may be configured such that, on a plane including the optical axes of the first projecting optical system and the second projecting optical system, a second angular difference between an angle formed between the chief ray of light emitted from the lower end of the image source and an optical axis of the second projecting optical system and an angle formed between the chief ray of light emitted from the upper end of the image source and the optical axis of the second projecting optical system is smaller than a divergence angle of a light beam emitted from a central portion of the image source and then emerged from the intermediate optical system as a diverging beam.

The screen may be tilted by a predetermined tilt angle with respect to a plane perpendicular to the optical axis of the second projecting optical system, and either of the first angular difference and the second angular difference is equal to or greater than θ/M, where θ is an absolute value of the predetermined tilt angel, and M is a projection magnification of the projection device.

The intermediate optical system may include at least one prism.

The intermediate optical system may be configured to compensate for chromatic aberration.

The intermediate optical system may consist of multiple prisms, at least one of the multiple prisms being formed of material having different Abbe's number than other prisms.

### BRIEF DESCRIPTION OF THE ACCOMPANYING DRAWINGS

FIG. 1 schematically shows a configuration of a projection device according to an embodiment of the invention.

FIG. 2 is an enlarged side view of a projecting optical system with the optical path being developed, according to the embodiment of the invention.

FIG. 3 shows a positional relationship among optical elements according to the embodiment of the invention.

FIG. 4 shows an optical path in the vicinity of an intermediate optical system according to the embodiment.

FIG. 5 shows the degree of distortion of an image projected by the projection device according to the embodiment.

### DETAILED DESCRIPTION OF THE EMBODIMENTS

Hereinafter, referring to the accompanying drawings, scanning lenses according to embodiments of the invention will be described.

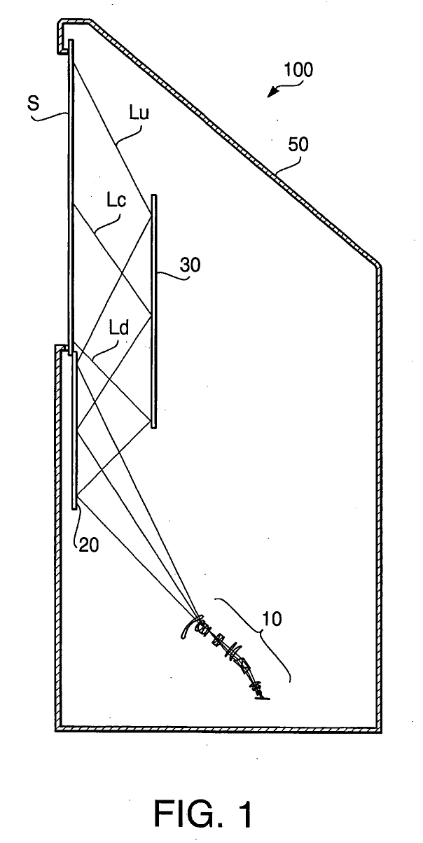

FIG. 1 schematically shows a configuration of a projection device 100 according to an embodiment of the invention. The projection device 100 has a housing 50, which accommodates a projecting optical system 10, a first mirror 20, a second mirror 30 and a screen S.

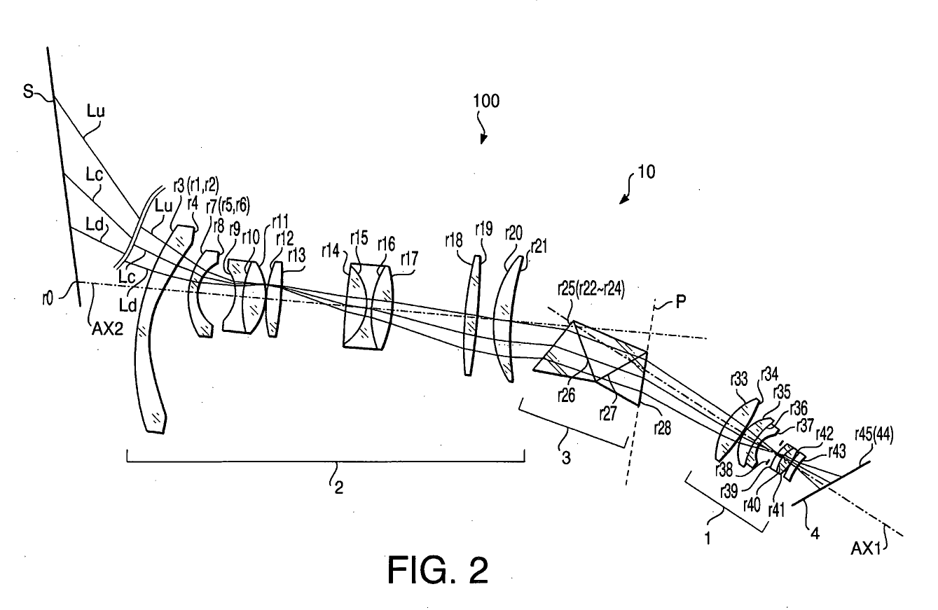

FIG. 2 is an enlarged side view of the projecting optical system 10 with the optical path thereof being developed. In FIG. 2, the first mirror 20 and the second mirror 30 are omitted for brevity. As shown in FIG. 2, the projecting optical system 10 includes a first projecting optical system 1, an intermediate optical system 3, a second projecting optical system 2, and an image source 4.

In FIG. 2, AX1 denotes an optical axis of the first projecting optical system 1, and AX2 denotes an optical axis of the second projecting optical system 2. In FIG. 2, the optical axes AX1 and AX2 are indicated by dotted lines. FIG. 2 is, therefore, a cross sectional view of the projecting optical system 10 taken along a plane including the optical axes AX1 and AX2. It should be noted that the plane including the optical axes AX1 and AX2 divides the screen S substantially evenly along a vertical line passing the center of the screen S. In the following description, the plane including the optical axes AX1 and AX2 will be referred to as a reference plane.

In the projection device 100, the lenses and/or part of optical surfaces of each of the optical systems 1 and 2 are shifted with each other in order to compensate for aberration and/or distortion that cannot be compensated for by rotationally symmetrical optical systems. Thus, in the following description, in each projecting optical system 1 and 2, a line mostly coincides with the central axis of contained optical surfaces will be defined as an optical axis thereof. If all the central axes are shifted from each other, a line coincides with the central axis of the optical surface closest to a pupil will be defined as the optical axis of the optical system.

In the actual projection device 100, depending on the positional relationship among the optical elements, further mirrors may be provided, in addition to the first and second mirrors 20 and 30, to bend the optical path inside the projection optical system 10. In the following description, however, each element will be illustrated with developing the optical axis (i.e., assuming that all the optical elements are arranged on the reference plane).

The image source 4 displays an image, which is projected on the screen S in an enlarged manner, using light emitted by a light source (not shown). As the image source 4, various devices such as a transmission type LCD (Liquid Crystal Display), a reflection type LCD, and DMDTM. The light emitted (transmitted or reflected) by the image source 4 carrying the image passes through the first projecting optical system 1 and forms an intermediate image on an intermediate image plane P. According to the embodiment, the image plane P substantially coincides with a surface which is the most first projecting optical side surface of the intermediate optical system 3.

The intermediate optical system 3 includes three triangular prisms arranged in the vicinity of the image plane P. The intermediate optical system 3 connects pupils of the projecting optical systems 1 and 2. The intermediate optical system 3 deflects the light forming the intermediate image and directs the same to the second projecting optical system 2. The second projecting optical system 2 diverges the light that enters via the intermediate optical system 3. The diverging light emerged from the second projecting optical system 2 (i.e., the projecting optical system 10 ) is reflected by the first mirror 20 and second mirror 30 in this order, and obliquely incident on the screen S from behind (i.e., on an inner surface of the screen S). With this configuration, the image displayed on the image source 4 is projected on the screen S.

In FIGS. 1 and 2, a chief ray of light, on the reference plane, forming the upper end portion of the image projected on the screen S is referred to as a chief ray Lu, a chief ray of light, on the reference plane, forming the central portion of the image projected on the screen S is referred to as a chief ray Lc, and a chief ray of light, on the reference plane, forming the lower end portion of the image projected on the screen S is referred to as a chief ray Ld. It is noted that, in the following description, an upper end of the image and lower end of the image correspond to the upper and lower ends of the image on the reference plane, respectively.

On the inner surface of the screen S, a thin-film type Fresnel lens (not shown) is adhered so that the rays obliquely incident on the inner surface of the screen S emerge from the front surface (i.e., from the viewer side) substantially perpendicular to the surface of the screen S.

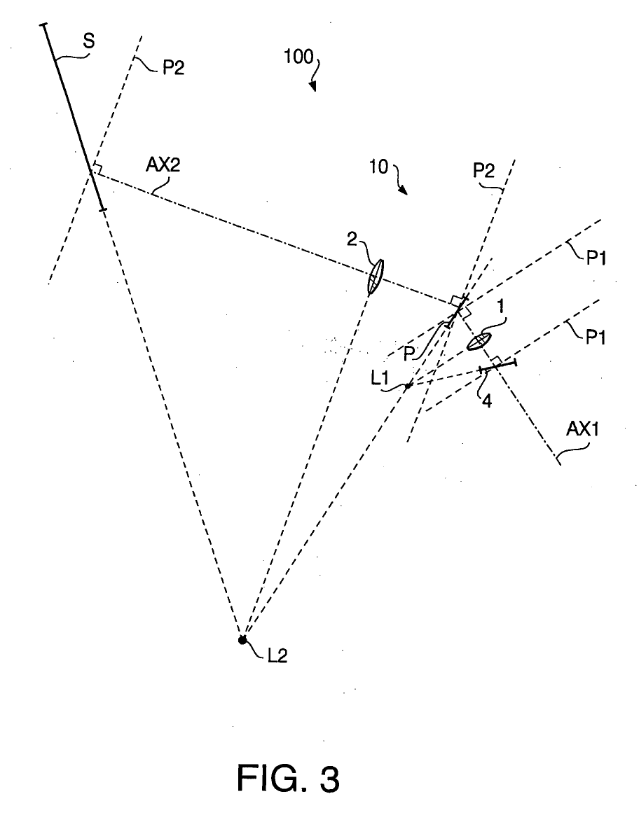

FIG. 3 shows a positional relationship of the screen S and elements of the projecting optical system 10. In FIG. 3, for the sake of simplified explanation, each of the projecting optical systems 1 and 2 is represented by a single lens. In the projection device 100, the image source 4, the first projecting optical system 1 and the image plane P of the intermediate image are inclined with each other according to the Scheinpflug's law. That is, extended planes of the image source 4, a principal plane of the first projecting optical system I and the image plane P intersect at the same line (hereinafter, referred to as a first reference line) LI. Specifically, the image source 4 is tilted with respect to an imaginary plane (hereinafter, referred to as a first imaginary plane) P1 which is perpendicular to the optical axis AX1 of the first projecting optical system 1. Further, the image plane P is titled with respect to the first imaginary plane P1.

The screen S, the second projecting optical system 2 and the image plane P (the intermediate optical system 3 ) are also arranged in accordance with Scheinpflug's law. That is, extended planes of the screen S, a principal plane of the second projecting optical system 2, and the image plane P intersect with each other on the same line L2, which will be referred to as a second reference line. Specifically, the image plane P is tilted with respect to a second imaginary plane (i.e., a second imaginary plane) P2 which is perpendicular to the optical axis AX2 of the second projecting optical system 2. The screen S is tilted with respect to the second imaginary plane P2.

As described above, in the projection device 100, Scheinpflug's law is applied twice. Thus, the light emitted by the image source 4 that displays a rectangular image forms the intermediate image having a trapezoidal distortion via the first projecting device 1 with an in-focus condition. Then, the light that forms the intermediate image is incident on the second imaging projecting system, which forms an enlarged image on the screen S with canceling the trapezoidal distortion of the intermediate image. Thus, the user can observe the image that is not affected by the trapezoidal distortion.

The projection device 100 is configured that both the first projecting optical system 1 and the second projecting optical system 2 are substantially telecentric toward the intermediate image. With this configuration, the intermediate optical system 3 can be configured only to deflect the optical path. According to the embodiment, as described above and shown in FIG. 2, the intermediate optical system 3 includes multiple (three) triangular prisms, which can be manufactured inexpensively.

When the intermediate optical system 3 is composed of multiple triangular prisms, possible aberrations caused by the intermediate optical system 3 are limited to basic ones such as axial (longitudinal) chromatic aberration and spherical aberration. Therefore, in comparison with the conventional configuration where various aberrations due to decentering of optical elements are caused, compensation can be done relatively easily. It should be noted that, if the first and second projecting optical systems 1 and 2 are made completely telecentric toward the intermediate image, the axial chromatic aberration and the spherical aberration may not be compensated effectively.

Therefore, in the present embodiment, in order to make the intermediate optical system 3 have functions of compensating for the aberrations such as the axial chromatic aberration and spherical aberration, each of the first and second projecting optical systems 1 and 2 is configured to be substantially telecentric toward the intermediate image side with retaining a predetermined error (i.e., retaining certain incompleteness in terms of telecentricity). Therefore, in the following description of the embodiment and claims, the term “substantially telecentric” is used in such a manner.

The intermediate optical system 3 has a function of compensating for lateral chromatic aberration by appropriately combining refractive indexes and Abbe's numbers of the multiple prisms. Optionally or alternatively, by employing a diffractive element, the lateral chromatic aberration can be compensated for by the intermediate optical system 3.

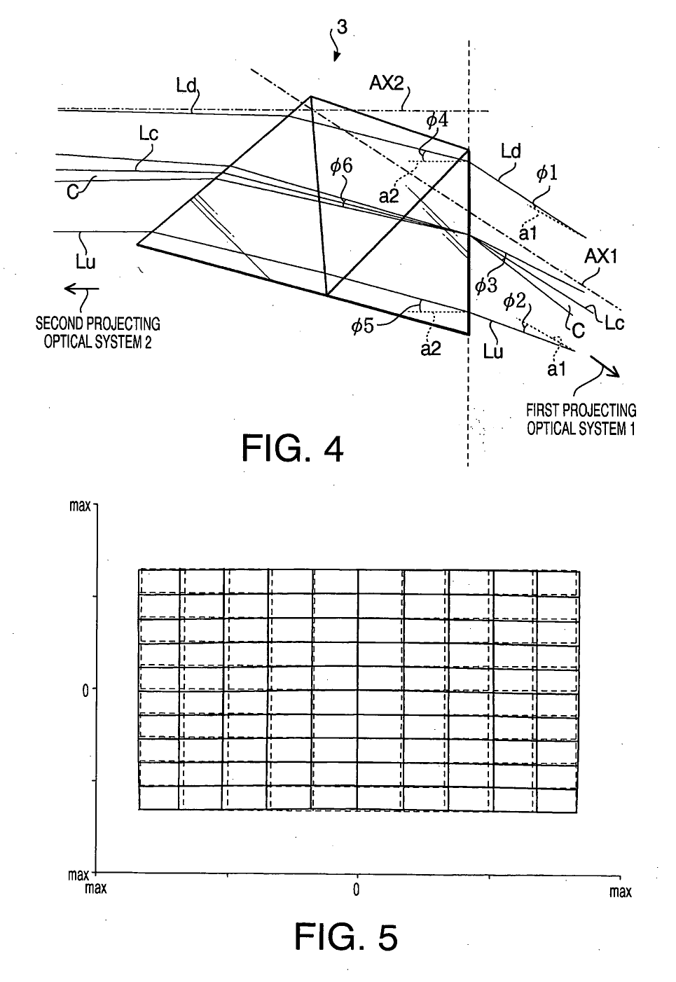

Next, referring to FIG. 4, the intermediate optical system 3 will be described in detail. FIG. 4 shows the optical path in the vicinity of the intermediate optical system 3. In FIG. 4, part of light forming the entire image projected on the screen S is shown. Specifically, in FIG. 4, rays of light C forming a central portion of the image projected on the screen S, including the chief ray Lc, are shown. Regarding light forming the uppermost and lowermost portions of the image, the chief rays Lu and Ld are shown. A dotted line a l is a line parallel with the optical axis AX1, and a dotted line a2 is a line parallel with the optical axis AX2.

The first projecting optical system 1 is configured to satisfy a following condition:
|φ1−φ2|<φ3,
where, φ1 represents an angle formed between the chief ray Ld and the dotted line al (i.e., the optical axis AX1 ), φ2 represents an angle formed between the chief ray Lu and the dotted line al (i.e., the optical axis AX1), and φ3 represents a convergence angle of light beam C converging on the intermediate image plane P. The above status will be referred to, in this specification, that the first projecting optical system 1 is substantially telecentric toward the intermediate image. The convergence angle is an angle, on the reference plane, of the light beam emerged from an exit pupil of the first projecting optical system 1.

The second projecting optical system 2 is configured to satisfy a following condition:
|φ4−φ5|<φ6,
where, φ4 represents an angle formed between the chief ray Ld and the dotted line a2 (i.e., the optical axis AX2 ), φ5 represents an angle formed between the chief ray Lu and the dotted line a2 (i.e., the optical axis AX2 ), and φ6 represents a divergence angle of light beam C converging on the intermediate image plane P. The above status will be referred to, in this specification, that the second projecting optical system 2 is substantially telecentric toward the intermediate image. The divergence angle is an angle, on the reference plane, of the light beam incident on an entrance pupil of the second projecting optical system 2.

When the axial chromatic aberration and spherical aberration are to be compensated, each of the projecting devices 1 and 2 is arranged to further satisfy the following conditions, respectively:
|φ1−φ2|≧θ/M; and
|φ4−φ5|≧θ/M,
where, θ represents a tilt angle of the screen S with respect to the second imaginary plane P2, and M represents a projection magnification of the projection device 100. With above configuration, it becomes possible to compensate for the aberrations in the intermediate optical system 3.

Next, a concrete example of the projection device 100 will be illustrated hereinafter.

TABLE 1 shows numerical examples of the projection device 100. In TABLE 1, the tilt angle φ (unit: degrees) of each element represents a tilted amount with respect to a plane perpendicular to both optical axes AX1 and AX2. The tilted amount is measured such that a counterclockwise direction represents a positive value. The shift amounts Y of each element in TABLE 1 represents a shifted amount of each element with respect to the optical axis with maintaining the tilted amount. The shift amount Y is measured such that a direction away from the first reference line LI and the second reference line L2 represents a positive value.

TABLE 1

| | | | | | | | | ASPHERICAL | | |
|---|---|---|---|---|---|---|---|---|---|---|
| | SUR- | RADIUS | SUR- | RE- | | | | SURFACE | | |
| | FACE | OF | FACE | FRAC- | | SHIFT | TILT | COEFFICIENT | | |
| | NUM- | CURVA- | DIS- | TIVE | ABBE's | AMOUNT | ANGLE | 4th | 6th | |
| | BER | TURE | TANCE | INDEX | NUMBER | Y | θ | DEGREE | DEGREE | DESCRIPTION |
| SCREEN S | 0 | INFINITY | 0.0 | | | | | | | |
| SECOND | 1 | INFINITY | 820.0 | | | | −34.3 | | | |
| PROJECTING | 2 | INFINITY | 0.0 | | | −12.0 | | | | |
| OPTICAL | 3 | 132.4 | 5.0 | 1.493 | 55.2 | | −3.8 | 1.1024E−06 | −6.6455E−11 | ROTATIONALLY |
| SYSTEM 2 | 4 | 45.0 | 0.0 | | | | | −3.3781E−07 | −2.6587E−09 | SYMMETRICAL |
| | | | | | | | | | | ASPHERICAL |
| | | | | | | | | | | SURFACE |
| | 5 | INFINITY | −5.0 | | | | 3.8 | | | |
| | 6 | INFINITY | 20.1 | | | 12.0 | | | | |
| | 7 | 27.7 | 3.6 | 1.831 | 28.7 | | | | | |
| | 8 | 14.7 | 15.3 | | | | | | | |
| | 9 | −15.8 | 3.0 | 1.767 | 37.8 | | | | | |
| | 10 | 34.3 | 8.9 | 1.693 | 49.1 | | | | | |
| | 11 | −23.7 | 0.5 | | | | | | | |
| | 12 | 46.2 | 5.7 | 1.846 | 23.8 | | | | | |
| | 13 | −202.3 | 27.4 | | | | | | | |
| | 14 | −6468.1 | 8.3 | 1.768 | 46.2 | | | | | |
| | 15 | −19.5 | 1.8 | 1.836 | 31.0 | | | | | |
| | 16 | 37.2 | 8.3 | 1.558 | 67.0 | | | | | |
| | 17 | −44.6 | 30.1 | | | | | | | |
| | 18 | 151.3 | 5.0 | 1.826 | 43.2 | | | | | |
| | 19 | −384.5 | 6.7 | | | | | | | |
| | 20 | 42.2 | 7.1 | 1.603 | 65.5 | | | | | |
| | 21 | 103.8 | 4.0 | | | | | | | |
| INTERMEDIATE | 22 | INFINITY | 0.0 | | | −5.2 | | | | |
| OPTICAL | 23 | INFINITY | 0.0 | | | | −14.7 | | | |
| SYSTEM 3 | 24 | INFINITY | 14.7 | | | | −19.9 | | | NO |
| | 25 | INFINITY | 14.0 | 1.709 | 30.3 | | 40.0 | | | COORDI- |
| | 26 | INFINITY | 14.7 | 1.751 | 26.4 | | −40.0 | | | NATE |
| | 27 | INFINITY | 10.0 | 1.814 | 43.8 | | 10.2 | | | MOVEMENT |
| | 28 | INFINITY | 18.5 | | | | | | | |
| FIRST | 29 | INFINITY | 0.0 | | | −0.9 | | | | |
| PROJECTING | 30 | INFINITY | 0.0 | | | | −14.9 | | | |
| OPTICAL | 31 | INFINITY | 12.2 | | | | | | | |
| SYSTEM 1 | 32 | INFINITY | 8.8 | | | | | | | |
| | 33 | 21.9 | 7.6 | 1.603 | 65.4 | | | −2.1811E−05 | −2.0839E−08 | ROTATIONALLY |
| | 34 | −75.6 | 0.6 | | | | | −2.9204E−06 | 1.3955E−08 | SYMMETRICAL |
| | | | | | | | | | | ASPHERICAL |
| | | | | | | | | | | SURFACE |
| | 35 | 13.9 | 5.7 | 1.720 | 50.0 | | | | | |
| | 36 | 29.4 | 2.0 | 1.787 | 25.3 | | | | | |
| | 37 | 8.1 | 8.1 | | | | | | | |
| | 38 | INFINITY | 0.5 | | | | | | | |
| | 39 | 27.0 | 2.0 | 1.771 | 30.5 | | | | | |
| | 40 | 10.6 | 4.0 | 1.830 | 42.4 | | | | | |
| | 41 | −18.5 | 0.5 | | | | | | | |
| | 42 | 33.8 | 2.2 | 1.821 | 41.1 | | | −3.6117E−04 | 2.2988E−06 | ROTATIONALLY |
| | 43 | 13.1 | 0.0 | | | | | −4.0140E−04 | 2.9526E−06 | SYMMETRICAL |
| | | | | | | | | | | ASPHERICAL |
| | | | | | | | | | | SURFACE |
| | 44 | INFINITY | 1.3 | | | | −26.5 | | | |
| IMAGE | 45 | INFINITY | 0.0 | | | 3.7 | | | | |
| SOURCE 4 | | | | | | | | | | |

In TABLE 1, surface number (#) 0 represents the screen S. Surfaces #1 -#21 represent the second projecting optical system 2. Surfaces #22 -#28 represent the deflection optical system, and surfaces #29 -#44 represent the first projecting optical system 1. Surface #45 represents the image source 4.

Surfaces #1, #2, #5, #6, #22 -#24, #29 -#32, #44 are imaginary surfaces (decenter defining surfaces) for defining decentered condition such as the shift and tilted amount of the subsequent surface. Surfaces #25 -#27 are surfaces of the three triangular prisms of the deflection optical system 3, which surfaces also function as decenter defining surfaces. It should be noted that the coordinate system after the decentering is a relative coordinate system which depends on the condition of the decenter defining surfaces. It should be noted that, in the surface #24 -#27, shift of the coordinate system due to tilting thereof is not taken into account, and the coordinate system based on the condition of the surface #21 is used.

As shown in TABLE 1, the surfaces #3, #4, #33, #34, #42 and #43 are rotationally symmetrical aspherical surfaces. Generally, a shape of the aspherical surface is expressed by a sag amount which is a distance from a tangential plane to the aspherical surface at the optical axis thereof. Specifically, given that the sag at a point whose height from the rotational axis is h is indicated as X(h), the curvature (1/r) of the aspherical surface on the optical axis (i.e., rotational axis) is C, a conical coefficient is K, and aspherical surface coefficients are A₄, A₆, . . . , the sag X(h) is expressed by formula below.

$$X ( h ) = \frac{{Ch}^{2}}{1 + \sqrt{1 - ( K + 1 ) {C}^{2} {h}^{2}}} {A}_{4} {h}^{4} + {A}_{6} {h}^{6} + ⋯$$

It should be noted that in the expression of the aspherical coefficients, each value in TABLE 1 represents a radix number, and a number on the right-hand side of “E” represents a power. In the embodiment, the conical coefficient K and aspherical coefficients for degrees that are not indicated herein are zero.

It is assumed that the image source 4 is configured such that the height H is 10.46 mm, a length in a direction perpendicular to the height H (i.e., a direction corresponding to the horizontal direction of the image projected on the screen) is 18.85 mm.

According to the embodiment, the first angular difference |φ1−φ2| on the intermediate image side of the first projecting optical system 1 is 3.17°, while the convergence angle φ3 is 6.59°. The second angle difference |φ4−5 | on the intermediate image side of the second projecting optical system 2 is 5.53°, while the divergence angel φ6 is 10.7°. Thus, it is understood that each of the first projecting optical system 1 and the second projecting optical system 2 is substantially telecentric toward the intermediate image.

Further, according to the embodiment, the projection magnification M is 71.43, the tilt angle θ of the screen S with respect to the second imaginary surface P2 is 34.3°. Therefore, θ/M=0.48°, which is smaller than either of the fires angular difference |φ1−φ2| or the second angular difference |φ4−φ5|. That is, the intermediate optical system 3 according to the invention, since the first and second projecting optical systems 1 and 2 are configured to be substantially telecentric toward the intermediate image, the axial chromatic aberration and the spherical aberration can be suppressed when the light passes through the intermediate optical system 3.

FIG. 5 shows the degree of distortion of an image projected by the projection device 100 according to the embodiment. In FIG. 5, solid lines represent an image projected on the screen S, while the broken lines represent an ideal image having no distortion. It is understood from FIG. 5 that, in the image projected by the projection device 100 configured as described above, the distortion is well eliminated, and is very close to the ideal image.

It should be note that the invention should not be limited to the configuration described above, and various modification can be derived without departing from the aspects of the invention. For example, each of the multiple triangular prisms of the intermediate optical system 3 may be modified such that a surface facing the first projecting optical system 1 or the second projecting optical system 2 is formed as a cylindrical surface in order to compensate for curvature of field, or to adjust the aspect ratio of the image projected on the screen S. Further, the intermediate optical system 3 may included additional optical element having a power to maintain the substantial telecentricity of the first and/or second projecting optical systems 1 and/or 2.

In the above-described embodiment, the intermediate optical system 3 consists of three triangular prisms. In order to reduce chromatic aberration, specifically, angular chromatic aberration, it is preferable that at least one of the three prisms is made of material having different Abbe's number from the other prisms, as shown in TABLE 1.

In the above-described embodiment, the intermediate optical system 3 consists of three triangular prisms. However, the invention need not limited to this illustrative structure, and less than three optical elements or more than three optical elements can be used to configure the intermediate optical system.

The present disclosure relates to the subject matter contained in Japanese Patent Application No. 2005-202796, filed on Jul. 12, 2005, which is expressly incorporated herein by reference in its entirety.

What is claimed is:

1. A projection device, comprising:
an image source unit configured to emit light carrying an image having a rectangular shape;
a first projecting optical system configured to form an intermediate image carried by the light emitted by the image source unit, the intermediate image having a trapezoidal shape due to trapezoidal distortion;
a second projecting optical system; and
an intermediate optical system configured to lead light from the first projecting optical system to the second projecting optical system, the second projecting optical system being configured to obliquely project light deflected by the intermediate optical system to a screen of the projection device, the image projected on the screen having a shape similar to the image provided by the image source,
wherein each of the first projecting optical system and the second projecting optical system is configured to be substantially telecentric toward the intermediate image.

2. The projection device according to claim 1,
wherein the first projecting optical system is configured such that, on a plane including the optical axes of he first projecting optical system and the second projecting optical system, a first angular difference between an angle formed between a chief ray of light emitted from a lower end of the image source and an optical axis of the first projecting optical system and an angle formed between a chief ray of light emitted from an upper end of the image source and the optical axis of the first projecting optical system is smaller than a convergence angle of a light beam emitted from a central portion of the image source and incident on the intermediate optical system as a converging beam via the first projecting optical system, and
wherein the second projecting optical system is configured such that, on a plane including the optical axes of the first projecting optical system and the second projecting optical system, a second angular difference between an angle formed between the chief ray of light emitted from the lower end of the image source and an optical axis of the second projecting optical system and an angle formed between the chief ray of light emitted from the upper end of the image source and the optical axis of the second projecting optical system is smaller than a divergence angle of a light beam emitted from a central portion of the image source and then emerged from the intermediate optical system as a diverging beam.

3. The projection device according to claim 2,
wherein the screen is tilted by a predetermined tilt angle with respect to a plane perpendicular to the optical axis of the second projecting optical system, and
wherein either of the first angular difference and the second angular difference is equal to or greater than θ/M, where θ is an absolute value of the predetermined tilt angel, and M is a projection magnification of the projection device.

4. The projection device according to claim 1,
wherein the intermediate optical system includes at least one prism.

5. The projection device according to claim 1,
wherein the intermediate optical system is configured to compensate for chromatic aberration.

6. The projection device according to claim 1,
wherein the intermediate optical system comprises multiple prisms, at least one of the multiple prisms being formed of material having different Abbe's number than other prisms.
